(19) United States
(12) Patent Application Publication
(10) Pub. No.: US 2026/0225678 A1
(43) Pub. Date: Aug. 6, 2026

(54) BRACKET

(71) Applicant: DART FLYSCREENS LTD, London (GB)

(72) Inventor: Stephen SLEDDON, London (GB)

(21) Appl. No.: 19/154,865

(22) PCT Filed: Feb. 6, 2024
(86) PCT No.: PCT/EP2024/052907

§ 371 Date: Aug. 8, 2025

(30) Foreign Application Priority Data
Feb. 10, 2023 (GB) 2301905.2

(51) Int. Cl. B62J 17/04

(52) U.S. Cl. CPC B62J 17/04

(57) ABSTRACT

The present invention provides a bracket for attaching a windshield to a motorcycle, the bracket comprising a main body and an abutment element. The main body comprises a windshield attachment portion for attachment to the windshield, a motorcycle attachment portion for attachment to the motorcycle, and a central portion extending therebetween. The abutment element comprises a head portion connected to the main body and an abutment portion extending from the head portion and having a first abutment surface. The first abutment surface is configured to abut a first motorcycle surface to restrict pivoting of the main body about an attachment point of the motorcycle attachment portion to the motorcycle. The central portion comprises a longitudinally-extending elongate slot and the head portion of the abutment element is slidably mounted in the elongate slot.

### FIELD OF THE INVENTION

The present invention relates to a bracket, and particularly to a bracket for attaching a windshield to a motorcycle.

### BACKGROUND

Some motorcycles include an integral windshield or analogous wind protection fairing as part of their design in order to provide wind protection to the rider. However, many motorcycles do not come with any wind protection as standard. Many riders find this type of motorcycle appealing from a design and styling viewpoint but in practice the lack of wind protection can be detrimental to the comfort and overall riding experience of the rider. There is a variety of aftermarket windshields available to address this problem, and there are several ways in which a windshield can be secured to a motorcycle.

One of the favoured ways to attach a windshield to a motorcycle is to use the motorcycle's own headlight brackets. These are common to many conventionally designed motorcycles and take the form of a pair of brackets which hold the headlight at points on or near the headlight's horizontal diameter, as viewed from the front. The headlight brackets are usually rigidly joined to the front forks or other convenient part of the motorcycle.

Conveniently, the windshield can be attached to a motorcycle using a pair of brackets which attach directly to the same mounting points on the headlight brackets as the headlight itself. However, one issue is that, in use, there is a tendency for these brackets to pivot backwards under pressure exerted on the front surface of the windshield which can reduce the level of wind protection provided by the windshield. Furthermore, different motorcycles can have differently shaped and/or sized headlight brackets which creates compatibility challenges and usually requires the manufacture of different brackets for windshield attachment, customised to fit different headlight brackets.

The present invention has been devised in light of the above considerations.

### SUMMARY

In a first aspect, there is provided a bracket for attaching a windshield to a motorcycle, the bracket comprising:
a main body comprising a windshield attachment portion for attachment to the windshield, a motorcycle attachment portion for attachment to the motorcycle, and a central portion extending therebetween; and
an abutment element comprising a head portion connected to the main body and an abutment portion extending from the head portion and having a first abutment surface configured to abut a first motorcycle surface to restrict pivoting of the main body about an attachment point of the motorcycle attachment portion to the motorcycle;
wherein the central portion comprises a longitudinally-extending elongate slot and the head portion of the abutment element is slidably mounted in the elongate slot.

As discussed above, backward pivoting of the windshield during forward travel under the influence of pressure exerted on the front surface of the windshield is undesirable as it reduces the wind protection provided by the windshield which can in turn be detrimental to the comfort and overall riding experience of the rider. Advantageously, the present bracket resists backward pivoting during travel through the abutment between the first abutment surface and the first motorcycle surface. Specifically, in use, the abutment between the first abutment surface and the first motorcycle surface counteracts and balances out the force due to the pressure exerted on the front surface of the windshield, and further transmitted to the main body of the bracket. This allows the main body of the bracket (and thus the windshield attached thereto) to remain stationary relative to the motorcycle during travel.

Furthermore, the longitudinal slidability of the abutment element along the elongate slot allows variation of the longitudinal position of the abutment element along the central portion of the main body. This allows the rider to vary the location on the motorcycle where the first abutment surface abuts the first motorcycle surface which also varies the angle between the longitudinal extension of the abutment portion and the first motorcycle surface. This is advantageous for at least two reasons.

Firstly, it can compensate for design differences in different motorcycles to ensure the bracket's consistent and reliable performance as well as compatibility with the different motorcycles. For example, when the bracket is attached to a respective headlight bracket of the motorcycle, the longitudinal slidability of the abutment element along the elongate slot can be used to compensate for differences in shape and/or size of headlight brackets on different motorcycles which cause the headlight brackets to be angled differently to the in-use horizontal direction. That is, varying the angle between the longitudinal extension of the abutment portion and the first motorcycle surface can compensate for differences in the angle that the headlight bracket forms with the in-use horizontal direction, which can ensure that the windshield can be orientated in the same manner relative to different motorcycles. This can improve the bracket's compatibility, while at the same time ensuring resistance to undesirable pivoting of the windshield by virtue of the abutment between the first abutment surface and the first motorcycle surface.

Secondly, longitudinally sliding the abutment element along the elongate slot and thus varying the angle between the longitudinal extension of the abutment portion and the first motorcycle surface allows the rider to angularly adjust the windshield, e.g. to better suit their preferences or height.

Optional features of the invention are discussed below. The invention includes the combination of the aspects and optional features described except where such a combination is clearly impermissible or expressly avoided.

The windshield attachment portion may be elongate. The windshield attachment portion may be planar. For example, the windshield attachment portion may be a plate, e.g. an elongate plate. The windshield attachment portion may have an outer surface and an opposing inner surface. The outer surface is for abutment of the windshield. The windshield has a front surface (front-facing during travel) and an opposing back surface. In use, the outer surface of the windshield attachment portion abuts the back surface of the windshield. The windshield attachment portion has a thickness (or depth). The thickness/depth of the windshield attachment portion is the distance between the outer and the inner surfaces of the windshield attachment portion. The direction from the outer to inner surface is defined herein as the front to rear direction. In use, a force will be applied to the windshield attachment portion via the windshield in a direction that is substantially aligned with the thickness/depth dimension of the windshield portion i.e. in a front to rear direction.

The windshield attachment portion may comprise at least one first bore for reception of a first connector for securing the windshield attachment portion to the windshield. The windshield attachment portion may comprise a plurality of (e.g. two) first bores, each for reception of a respective first connector for securing the windshield attachment portion to the windshield. The plurality of first bores may be longitudinally spaced relative to each other along the windshield attachment portion (e.g. where the windshield attachment portion is elongate such as an elongate plate). The/each first bore may extend (e.g. fully extend) through the thickness of the windshield attachment portion. The/each first connector may comprise an externally threaded surface. The/each first bore may comprise an internally threaded surface configured to engage with the externally threaded surface of the respective first connector. The/each first connector may be a pin, a screw or a bolt, for example.

The central portion may be elongate and may have opposing axial ends longitudinally spaced from one another. The central portion may be planar. For example, the central portion may be a plate, e.g. an elongate plate. The central portion is joined to the windshield attachment portion at a join. The join may be at a first of the opposing axial ends of the central portion. The central portion and the windshield attachment portion may be unitary in which case the join may be a fold.

The central portion may have inner and outer surfaces with a thickness or depth extending between the inner and outer surfaces. The inner surface of the central portion is preferably continuous with (albeit preferably angled with respect to) the inner surface of the windshield attachment portion and the outer surface of the central portion is preferably continuous with (albeit preferably angled with respect to) the outer surface of the windshield attachment portion.

The windshield attachment portion may form an angle greater than 0 and less than 180 degrees with the central portion at the join/fold such that the join/fold is a non-planar join/fold. The internal angle of the join/fold (i.e. the angle between the inner surface of the windshield attachment portion and the inner surface of the central portion) is the smaller one of the two explementary angles (i.e. two angles whose sum is 360 degrees) formed by the central portion and the windshield attachment portion. Correspondingly, the external angle of the join/fold (i.e. the angle between the outer surface of the windshield attachment portion and the outer surface of the central portion) is the larger one of the two explementary angles formed by the central portion and the windshield portion. The internal angle of the non-planar join/fold may be between 60 degrees and 150 degrees, e.g. between 70 and 140 degrees, such as between 80 and 140 degrees or 90 and 140 degrees, for example between 100 and 140 degrees or 110 and 140 degrees such as between 120 and 140 degrees, or 130 and 140 degrees, such as around 135 degrees.

The motorcycle attachment portion is preferably provided at a second of the opposing axial ends of the central portion. The motorcycle attachment portion may be planar. For example, the motorcycle attachment portion may be a plate. The central portion and the motorcycle attachment portion may be coplanar. The central portion and the motorcycle attachment portion may be provided by a single integral plate (e.g. an elongate, planar plate). In these embodiments, the motorcycle attachment portion will have inner and outer surfaces (with a thickness or depth extending between the inner and outer surfaces) which are continuous (and preferably coplanar) respectively with the inner and outer surfaces of the central portion.

The windshield attachment portion, the central portion and the motorcycle attachment portion may all be formed of a single integral plate with a fold at the first axial end of the central portion defining the join between the central portion and the windshield attachment portion. In these embodiments, the inner surfaces (and outer surfaces) of all of the windshield attachment portion, central portion and motorcycle attachment portion will be continuous.

The main body may comprise a weight-reduction cut-out (forming a recess in or an opening through the main body). The weight-reduction cut-out may be at or proximal the first axial end of the central portion. The weight-reduction cut-out may be longitudinally spaced from the elongate slot. The weight-reduction cut-out may be interposed between the elongate slot and the windshield attachment portion. The weight-reduction cut-out may be located at the join/fold where the central portion meets the windshield attachment portion.

The motorcycle attachment portion may comprise a second bore for reception of a second connector for securing the motorcycle attachment portion to the motorcycle at the attachment point. The second bore may extend (e.g. fully extend) through the thickness of the motorcycle attachment portion. The second connector may comprise a shaft and a head. The shaft may be inserted into the second bore. For example, the second connector may be a pin, screw, bolt.

The first abutment surface of the abutment element is configured to abut the first motorcycle surface to restrict pivoting of the main body about the axis of the second bore i.e. the second bore defines the attachment point.

The first motorcycle surface may be a surface of a headlight bracket of the motorcycle.

As discussed, the motorcycle attachment portion is attached to the motorcycle (using the second connector) at the attachment point. The attachment point may be axially aligned with or coincide with a headlight attachment point (i.e. a point of attachment of the headlight of the motorcycle to a headlight bracket of the motorcycle).

The first abutment surface is provided rearwards of the attachment point i.e. rearwards of the second bore (in a front to rear direction) such that the first abutment surface abuts the first motorcycle surface at a location rearwards of the attachment point/second bore along the front to rear direction. The head portion is interposed between the plane of the windshield attachment portion and the first abutment surface in the front to rear direction. Conveniently, this allows the force acting on the front surface of the windshield, to be transmitted via the main body of the bracket, to a location on the motorcycle rearwards of the attachment point. This prevents backward pivoting (i.e. along the front to rear direction) of the main body about the attachment point e.g. about the axis of the second bore.

The abutment portion of the abutment element extends from the head portion in a direction away (e.g. in the front-rear direction away) from the windshield attachment portion and/or the central portion of the main body, terminating at the first abutment surface. Thus, the first abutment surface faces away from the windshield attachment portion.

The abutment element has a thickness extending between an inner surface (which abuts/faces the inner surface of the central portion and/or the elongate slot at the head portion) and an opposing outer surface, the thickness extending along the same direction as the thickness of the central portion of the main body. The abutment element may have a larger thickness at or proximal the head and/or the first abutment surface. Conveniently, an increased thickness at or proximal the abutment surface can increase the contact area between the first abutment surface and the first motorcycle surface for better contact and force transmission.

The head portion of the abutment element may comprise a head bore for reception of an abutment element fastener. The head bore may extend fully or partially through the thickness of the head portion (i.e. between the inner and outer surfaces of the head portion). The head bore within the head portion of the abutment element may comprise an internal threaded surface.

The abutment element fastener is configured for retaining the abutment element within the elongate slot of the central portion and for fixing the longitudinal position of the abutment element along the elongate slot. The abutment element fastener may comprise a shaft terminating in a head. The head may have a diameter which is greater than the width of the elongate slot. The shaft may have an external threaded surface for engagement with the internal surface of the head bore. For example, the abutment element fastener may be a bolt or a screw.

The head portion preferably has a transverse/width dimension (perpendicular to its thickness and perpendicular to the elongation of the elongate slot) that is greater than the width of the elongate slot (where the width of the elongate slot is perpendicular to its longitudinal axis and perpendicular to the thickness of the central portion). The shaft of the abutment element fastener may be inserted into the head bore of the head portion through the elongate slot of the bracket. Thus, the head portion of the abutment element and the head of the abutment element fastener may together sandwich a part of the central portion of the main body.

The head portion of the abutment element may have a circular cross-section along a plane parallel to the plane of the central portion. The head portion may be rotationally symmetrical around the longitudinal axis of the bore extending therethrough. The head portion may have a thickness larger than the thickness of the abutment portion and/or of the first abutment surface.

The first abutment surface may be a continuous smooth surface e.g. a rounded surface such as a rounded convex surface. The first abutment surface may be curved around an axis aligned with the thickness direction of the abutment portion/central portion e.g. around an axis parallel to the axis of the head bore. For example, the first abutment surface may have a convex semi-circular profile. Conveniently, the first abutment surface having a continuous smooth profile can ensure a plurality of possible contact points available for contact with the first motorcycle surface. Thus, sufficient contact can be ensured between the first abutment surface and the first motorcycle surface for all longitudinal positions of the abutment element along the elongate slot such that the abutment element can reliably perform its anti-pivoting function.

The abutment element may be rotationally fixed relative to the main body of the bracket within the elongate slot. For example, the head portion may comprise at least one anti-rotation projection e.g. on its inner surface. The at least one anti-rotation projection may be slidably received within and extend into the elongate slot of the main body of the bracket to rotationally fix the abutment element relative thereto. The anti-rotation projection may extend longitudinally inside the elongate slot. That is, the anti-rotation projection may linearly extend across the inner surface of the head portion. The anti-rotation projection may be provided by a plurality of (e.g. two) linearly arranged individual projections. The plurality of projections may be linearly arranged on the inner surface of the head portion, on either side of the head bore for reception of the abutment element fastener.

Alternatively, the abutment element may be rotatable relative to the main body to vary an angle that the first abutment surface forms with the longitudinal axis of the elongate slot. The abutment element may be rotatable around an axis substantially aligned with the thickness of the central portion. The abutment element may be rotatable around the longitudinal axis of the head bore. Conveniently, the rotatability can ensure sufficient contact between the first abutment surface and the first motorcycle surface. The rotatability may also vary the location on the motorcycle where the first abutment surface abuts the first motorcycle surface.

The abutment element may be axially symmetrical. Conveniently, this can simplify its manufacturing.

The abutment portion of the abutment element may be bifurcated into a first branch and a second branch, the first branch extending between the head portion and the first abutment surface, and the second branch extending between the head portion and a second abutment surface for abutting a second motorcycle surface. In use, the abutment between the second abutment surface and the second motorcycle surface further restricts pivoting of the main body about the attachment point. When the first motorcycle surface is a surface on a headlight bracket, the second motorcycle surface may be a surface on the same headlight bracket. In use, the first and the second motorcycle surfaces may be spaced from one another along a top surface of the headlight bracket. The second branch may form an internal angle greater than 0 and less than 180 degrees with the first branch. That is, the internal angle may be between 10 and 160 degrees, such as between 20 and 140 degrees or 20 and 130 degrees, for example between 20 and 110 degrees or 30 and 90 degrees e.g. between 30 and 80 degrees or 40 and 70 degrees such as between 40 and 70 degrees or 50 and 70 degrees such as around 60 degrees.

The second abutment surface may comprise any one or any combination of the optional features described with respect to the first abutment surface. The second branch may be identical to the first branch but mirrored relative to the axis of symmetry of the abutment element. Advantageously, such a bifurcated design of the abutment portion can ensure an axially symmetrical abutment element, which can simplify its manufacturing.

When the abutment element is rotatable relative to the main body and its abutment portion is bifurcated as discussed above, the rotatability can advantageously ensure that both the first and second abutment surfaces simultaneously contact respectively the first and second motorcycle surfaces for optimised abutment.

The abutment element (i.e. the head portion, abutment portion (e.g. the first and second branch) and abutment surface(s)) may be integrally formed, e.g. by injection moulding.

In a second aspect, there is provided a kit for attaching a windshield to a motorcycle, said kit comprising two brackets, each as defined in the first aspect. The kit may further comprise a plurality (e.g. four) first connectors. The kit may further comprise a plurality of (e.g. two) second connectors. The kit may further comprise a windshield attached thereto.

In a third aspect there is provided a method of manufacturing the bracket as defined in the first aspect, the method comprising:
providing a unitary main body blank;
deforming the main body blank to form a fold between the windshield attachment portion and the central portion to form the main body;
providing the abutment element; and
slidably mounting the head portion of the abutment element inside the elongate slot.

Providing the unitary main body blank may include integrally moulding (e.g. injection moulding) the unitary main body blank.

The method may further comprise cutting the main body blank. Cutting the main body blank may be performed to provide the elongate slot, the weight-reduction cut-out, the second and/or the/each first bore. When the cutting step is performed to provide the/each first bore, it may also include cutting the inside of the/each first bore to provide the respective internally threaded surface(s). The step of cutting the main body blank may be performed before deforming the main body blank.

Providing the abutment element may be include integrally forming the head portion and the abutment portion, e.g. by integral moulding such as injection moulding.

In a fourth aspect, there is provided a motorcycle comprising a windshield, the windshield being attached to the motorcycle via a pair of brackets as defined in the first aspect.

### SUMMARY OF THE FIGURES

Embodiments and experiments illustrating the principles of the invention will now be discussed with reference to the accompanying figures in which:

FIGS. 1 and 2 respectively show a partial front view and a partial side view of a windshield attached to a motorcycle;

FIG. 3 shows a perspective side view of a bracket according to an embodiment of the invention;

FIGS. 4A-4E respectively show side views, a front and a back view, and a perspective view of an abutment element;

FIGS. 5A-5C show respective partial side views of a bracket comprising the abutment element of FIGS. 4A-4E and attached to respective different motorcycles;

FIGS. 6A-6B show the arrangement of FIGS. 5A-5B undergoing angular adjustment;

FIGS. 7A-7D show respectively show a front view, a side view, and perspective views of a variant of the abutment element of FIGS. 4A-4E;

FIGS. 8A-8C show respective partial side views of a bracket comprising the abutment element of FIGS. 7A-7D and attached to respective different motorcycles; and

FIGS. 9A-9B show the arrangement of FIGS. 8A-8C undergoing angular adjustment.

### DETAILED DESCRIPTION OF THE INVENTION

Aspects and embodiments of the present invention will now be discussed with reference to the accompanying figures. Further aspects and embodiments will be apparent to those skilled in the art.

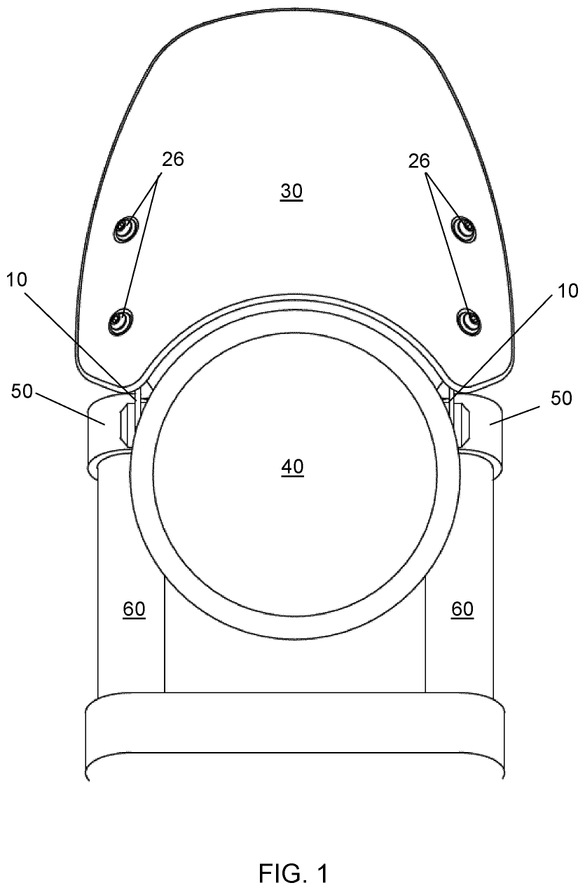

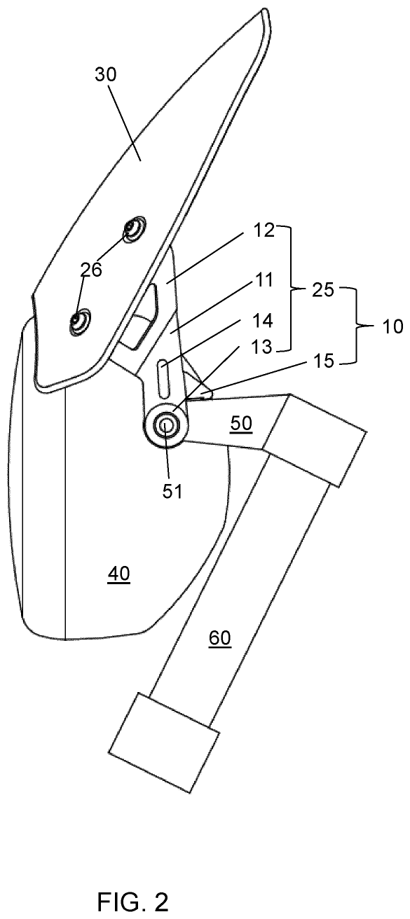

The present invention provides a bracket 10 for attaching a windshield 30 to a motorcycle as shown in FIGS. 1 and 2. Specifically, FIGS. 1 and 2 respectively show a partial front view and a partial side view of the windshield 30 being attached to a motorcycle (only the front forks 60, headlight 40, and headlight brackets 50 of which are shown) via a pair of brackets 10 according to an embodiment of the present invention. The windshield 30 is attached to each bracket 10 via a respective pair of first connectors 26. In this example the headlight brackets 50 of the motorcycle are attached to the front forks 60 at a pair of respective attachment points 51 (see FIG. 2). The pair of headlight brackets 50 support the front-mounted headlight 40 of the motorcycle. Each bracket 10 is attached to the motorcycle via a respective second connector (the second connector in FIG. 2 coincides with the shown attachment point 51 and thus is not labelled in the interest of clarity).

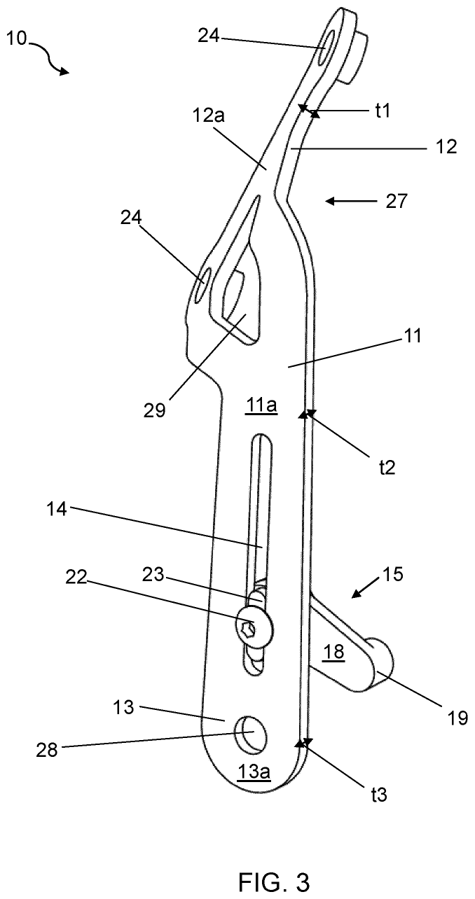

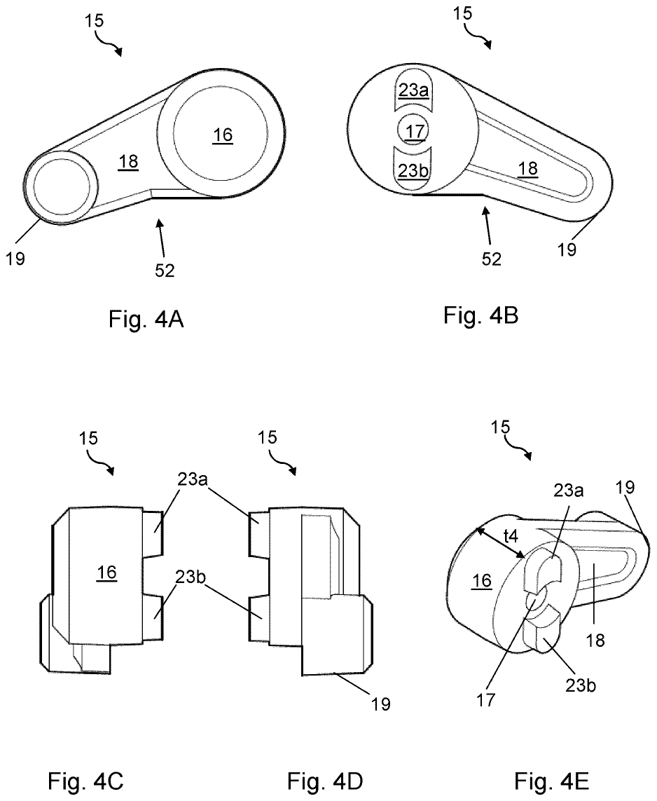

The features of a single of the two brackets (i.e. “the bracket”) 10 are described below with reference to FIGS. 2 and 3. The bracket 10 comprises a main body 25 and an abutment element 15 connected to the main body. The main body comprises a windshield attachment portion 12 for attachment to the windshield 30, a motorcycle attachment portion 13 for attachment to the motorcycle, and a central portion 11 extending therebetween. The abutment element 15 is connected to the main body 25 via its head portion 16 (see FIGS. 4A-8C). Specifically, the head portion 16 of the abutment element is slidably mounted in a longitudinally-extending elongate slot 14 in the central portion of the main body via an abutment element fastener 22 (see FIG. 3).

The head portion 16 of the abutment element 15 comprises a head bore 17 for reception of the abutment element fastener 22, the head bore comprising an internal threaded surface. The abutment element fastener 22 is for retaining the abutment element 15 within the elongate slot 14 of the central portion 13 and for fixing the longitudinal position of the abutment element along the elongate slot (see FIG. 3). The abutment element fastener comprises a shaft terminating in a head. The shaft has an external threaded surface for engagement with the internal surface of the head bore 17. For example, the abutment element fastener may be a bolt or a screw.

To attach the abutment element 15 to the main body 25 of the bracket 10, the shaft of the abutment element fastener 22 is inserted into the head bore 17 of the head portion 16 through the elongate slot 14 of the central portion 11. Because the head portion has a transverse dimension that is greater than the width of the elongate slot, and the diameter of the head of the abutment element fastener 22 is also greater than the width of the elongate slot, once the shaft is inserted into the head bore and into the elongate slot, the head portion of the abutment element and the head of the abutment element fastener together sandwich a part of the central portion of the main body 25.

In addition to the head portion 16, the abutment element 15 further comprises an abutment portion 18 extending from the head portion 16. The abutment portion 18 has a first abutment surface 19 configured to abut a first motorcycle surface (which is a top surface on one of the two headlight brackets 50 of the motorcycle) to restrict pivoting of the main body 25 about an attachment point 51 of the motorcycle attachment portion 13 to the motorcycle. In the present examples, the attachment point 51 of the motorcycle attachment portion 13 to the motorcycle coincides with the attachment point 51 of the headlight 40 to a respective one of the headlight brackets 50.

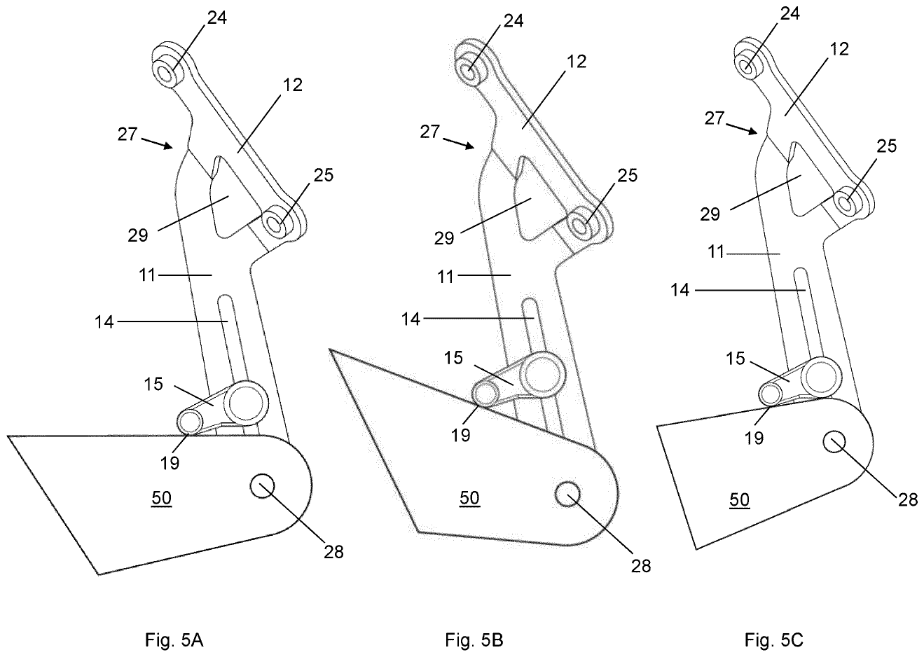

In use, the first abutment surface 19 of the abutment element 15 is provided rearwards of the attachment point 51 (in a front to rear direction) such that the first abutment surface abuts the first motorcycle surface at a location rearwards of the attachment point along the front to rear direction. Consequently, the head portion 16 of the abutment element is interposed between the plane of the windshield attachment portion 12 and the first abutment surface 19 in the front to rear direction (see FIGS. 5A-5C, 6A-6B, 8A-8C, and 9A-9B). Furthermore, the abutment portion 18 of the abutment element 15 extends from the head portion 16 in a direction away (e.g. in the front-rear direction away) from the windshield attachment portion 12 and/or the central portion 11 of the main body, terminating at the first abutment surface 19. Thus, the first abutment surface faces away from the windshield attachment portion.

Conveniently, the above orientation of the first abutment surface 19 allows the force acting on the front surface of the windshield 30, to be transmitted via the main body 25 of the bracket 10, to a location on the motorcycle rearwards of the attachment point 51. This prevents backward pivoting (i.e. along the front to rear direction) of the main body 25 about the attachment point 51.

Features of the main body 25 are described in more detail with reference to FIG. 3. Firstly, the windshield attachment portion 12 is an elongate plate having an outer surface 12a for abutment of the windshield and an opposing inner surface (not shown). The windshield 30 has a front surface (front-facing during travel and shown in FIG. 1) and an opposing back surface (not shown). In use, the outer surface of the windshield attachment portion abuts the back surface of the windshield. The windshield attachment portion has a thickness t1 (or depth). The thickness/depth t1 of the windshield attachment portion is the distance between the outer and the inner surfaces of the windshield attachment portion. The direction from the outer to inner surface is defined herein as the front to rear direction. In use, a force will be applied to the windshield attachment portion via the windshield in a direction that is substantially aligned with the thickness/depth dimension of the windshield portion i.e. in a front to rear direction.

Furthermore, the windshield attachment portion comprises a pair of longitudinally spaced first bores 24 for reception the first connectors 26, each for securing the windshield attachment portion 12 to the windshield 30. The first bores fully extend through the thickness t1 of the windshield attachment portion. Each first connector 26 may comprise an externally threaded surface and each first bore 24 may comprise an internally threaded surface configured to engage with the externally threaded surface of the respective first connector. For example, the first connectors may each be a pin, a screw or a bolt.

Secondly, the central portion 11 of the main body 25 is also an elongate plate having opposing axial ends longitudinally spaced from one another. The central portion 11 has inner (not shown) and outer 11a surfaces with a thickness t2 or depth extending between the inner and outer surfaces. The central portion 11 extends longitudinally from a second of its two opposite axial ends, towards its first axial end. The first axial end of the central portion is curved around the direction of the central portion's thickness t2, towards the windshield attachment portion 12. The central portion 11 is joined to the windshield attachment portion 12 at a join 27 at the first axial end of the central portion. The windshield attachment portion, the central portion and the motorcycle attachment portion 13 are all formed of a single integral plate with a fold 27 at the first axial end of the central portion defining the join between the central portion and the windshield attachment portion. Thus, the inner surfaces (and outer surfaces 11a, 12a, 13a) of all of the windshield attachment portion, central portion and motorcycle attachment portion are continuous.

The windshield attachment portion 12 forms an angle greater than 0 and less than 180 degrees with the central portion 11 at the join/fold such that the join/fold is a non-planar join/fold. The internal angle of the join/fold (i.e. the angle between the inner surface of the windshield attachment portion and the inner surface of the central portion) is the smaller one of the two explementary angles (i.e. two angles whose sum is 360 degrees) formed by the central portion and the windshield attachment portion. Correspondingly, the external angle of the join/fold (i.e. the angle between the outer 12a surface of the windshield attachment portion and the outer surface 11a of the central portion) is the larger one of the two explementary angles formed by the central portion and the windshield portion. The internal angle of the non-planar join/fold may be between 60 degrees and 150 degrees, e.g. between 70 and 140 degrees, such as between 80 and 140 degrees or 90 and 140 degrees, for example between 100 and 140 degrees or 110 and 140 degrees such as between 120 and 140 degrees, or 130 and 140 degrees, such as around 135 degrees.

The main body 25 further comprises a weight-reduction cut-out 29 (forming an opening through the main body) at the join/fold 27 where the central portion 11 meets the windshield attachment portion 12. Thus, the weight-reduction cut-out is longitudinally spaced from the elongate slot 14. As such, the weight-reduction cut-out is interposed between the elongate slot and the windshield attachment portion.

Finally, the motorcycle attachment portion 13 is provided at a second of the opposing axial ends of the central portion 11, and as already discussed, is planar. The motorcycle attachment portion is coplanar with the central portion and has inner (not shown) and outer surfaces 13a (with a thickness t3 or depth extending between the inner and outer surfaces) which are continuous respectively with the inner and outer surfaces 11a of the central portion. Furthermore, the motorcycle attachment portion comprises a second bore 28 for reception of the second connector (not shown) for securing the motorcycle attachment portion to the motorcycle at the attachment point 51. The second bore 28 fully extends through the thickness t3 of the motorcycle attachment portion 13. The first abutment surface 19 of the abutment element 15 is configured to abut the first motorcycle surface to restrict pivoting of the main body 25 about the axis of the second bore 28. The second connector may comprise a shaft and a head. The shaft may be inserted into the second bore. For example, the second connector may be a pin, screw, bolt.

Next, features of the abutment element are described in detail with reference to FIGS. 4A-9B.

The abutment element 15 has a thickness t4 extending between an inner surface (which abuts/faces the inner surface of the central portion 11 and/or the elongate slot 14 at the head portion 16) and an opposing outer surface, the thickness t4 extending along the same direction as the thickness t2 of the central portion 11 of the main body 25. In the present examples, the head bore 17 extends partially through the thickness t4 of the head portion 16 (i.e. between the inner and outer surfaces of the head portion).

The head portion 16 of the abutment element 15 has a circular cross-section along a plane parallel to the plane of the central portion 11. The head portion 15 is rotationally symmetrical around the longitudinal axis of the head bore 17 extending therethrough. The head portion has a thickness larger than the thickness of the abutment portion and/or of the first abutment surface.

The first abutment surface 19 is a continuous smooth surface. That is, the first abutment surface has a convex semi-circular profile curved around an axis aligned with the thickness direction of the abutment portion/central portion e.g. around an axis parallel to the axis of the head bore 17. Conveniently, the first abutment surface 19 having a continuous smooth profile can ensure a plurality of contact points available for contact with the first motorcycle surface. Thus, sufficient contact can be ensured between the first abutment surface 19 and the first motorcycle surface for all longitudinal positions of the abutment element along the elongate slot such that the abutment element can reliably perform its anti-pivoting function.

The abutment element 15 of the present examples is integrally formed, e.g. by injection moulding.

Modifications to the abutment element 15 are possible. Two respective variants of the abutment element are discussed below respectively with reference to FIGS. 4A-6B and FIGS. 7A-9B.

Starting with the first variant, the abutment element 15 of FIGS. 4A-6B has a head portion 16 comprising a head bore 17, an abutment portion 18 extending from the head portion, and a first abutment surface 19, all as described above. In addition to these features, the abutment element 15 is rotationally fixed relative to the main body 25 of the bracket 10 within the elongate slot 14. This is achieved by a pair of anti-rotation projections 23a, 23b on the inner surface of the head portion 16 (i.e. the surface which abuts the inner surface of the central portion 11). Specifically, the anti-rotation projections are slidably received within and extend into and longitudinally inside the elongate slot 14 of the main body 25 of the bracket to rotationally fix the abutment element 15 relative thereto. The anti-rotation projections are linearly arranged on the inner surface of the head portion, on either side of the head bore 17.

In this variant, the abutment element 15 has a largest thickness at the first abutment surface 19. Conveniently, this can increase the contact area between the first abutment surface and the first motorcycle surface for better abutment and force transmission. Furthermore, the abutment portion 18 has a kink 52 in its bottom surface (i.e. the surface facing the top surface of the headlight bracket). Conveniently, the kink 52 angles the abutment portion 18 and thus the first abutment surface 19 towards the first motorcycle surface (i.e. towards the headlight bracket), to ensure better contact therebetween.

The abutment element 15 of the first variant as attached to the main body 25 of the bracket 10 is shown in FIGS. 5A-5C. FIGS. 5A-5C illustrate how sliding the head portion 16 of the abutment element along the elongate slot 14 can vary the angle that the longitudinal axis of the abutment element forms with the first motorcycle surface (which is on the top surface of the headlight bracket). Varying the angle in the manner allows the bracket 10 to be compatible with differently shaped/sized headlight brackets 50 whose different shape/size causes them to be angled differently relative to the in-use horizontal direction.

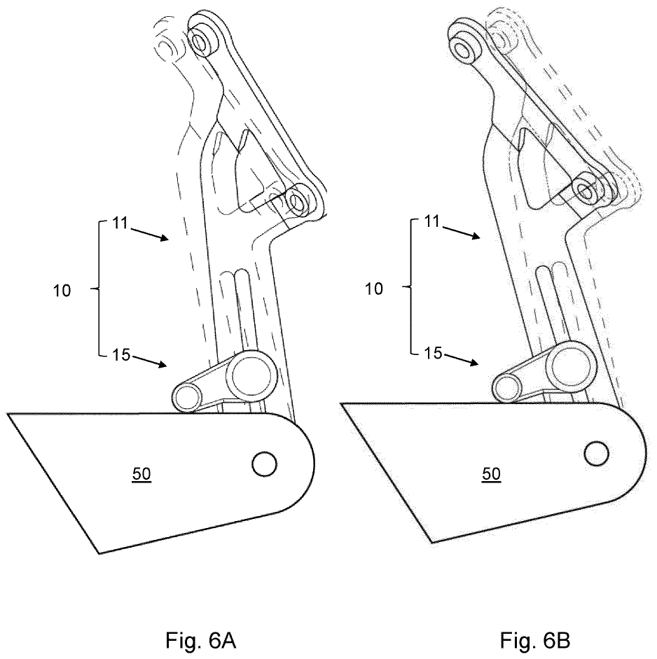

Furthermore, varying the longitudinal position of the head portion 16 of the abutment element 15 along the elongate slot 14 can be used to angularly adjust the bracket 10 (and the windshield 30 attached thereto) relative to the headlight bracket 50 of the motorcycle to which the bracket 10 is attached. This is shown in FIGS. 6A-6B where the bracket 10 is tilted along the front to rear direction (and vice versa, as indicated by the solid and dashed outlines of the bracket) to achieve the angular adjustment of the windshield 30. Conveniently, this functionality can be used to allow the rider to adjust the windshield to better fit their preferences and/or height.

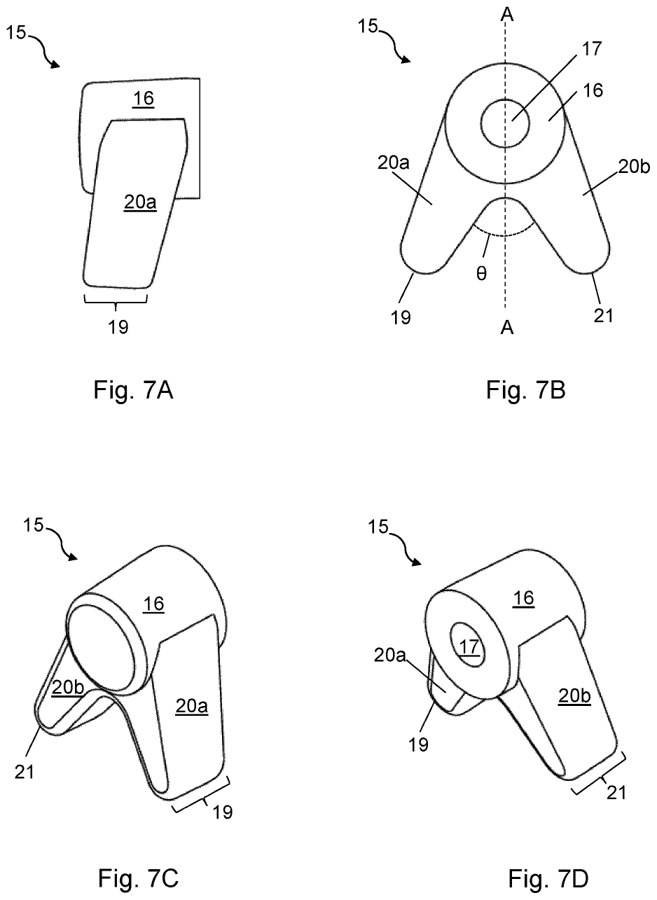

Turning to the second variant, the abutment element 15 of FIGS. 7A-6D also has a head portion 16 comprising a head bore 17, an abutment portion 18 extending from the head portion, and a first abutment surface 19, all as described above. However, the abutment portion of the abutment element of this variant is bifurcated into a first branch 20a and a second branch 20b, the first branch 20a extending between the head portion 16 and the first abutment surface 19, and the second branch 20b extending between the head portion 16 and a second abutment surface 21 for abutting a second motorcycle surface. In use, the abutment between the second abutment surface and the second motorcycle surface further restricts pivoting of the main body 25 about the attachment point 51. The second motorcycle surface is a surface on the same headlight bracket 50 as the first motorcycle surface. In use, the first and the second motorcycle surfaces are spaced from one another along a top surface of the headlight bracket 50.

The first 20a and second 20b branches form an internal angle, θ, which is greater than 0 and less than 180 degrees. That is, the internal angle θ may be between 10 and 160 degrees, such as between 20 and 140 degrees or 20 and 130 degrees, for example between 20 and 110 degrees or 30 and 90 degrees e.g. between 30 and 80 degrees or 40 and 70 degrees such as between 40 and 70 degrees or 50 and 70 degrees such as around 60 degrees.

The second 20b branch is identical to the first branch 20a but mirrored relative to the axis of symmetry A-A of the abutment element. Consequently, the second abutment surface 21 is identical to the first abutment surface 19 but mirrored relative to the axis of symmetry A-A of the abutment element 15.

By virtue of its bifurcation into two branches, the abutment element of this variant is axially symmetrical (around the axis of symmetry A-A shown FIG. 7B). Conveniently, its axial symmetry can simplify the abutment element's manufacturing.

In further contrast to the abutment element of the first variant, the abutment element of the second variant is rotatable relative to the main body 25 to vary an angle that the first/second abutment surface 19 forms with the longitudinal axis of the elongate slot. Specifically, abutment element is rotatable around an axis substantially aligned with the thickness t2 of the central portion 11. The abutment element 15 is thus rotatable around the longitudinal axis of the head bore 17. Conveniently, the rotatability can ensure that both the first 19 and second 21 abutment surfaces simultaneously contact respectively the first and second motorcycle surfaces for optimised abutment.

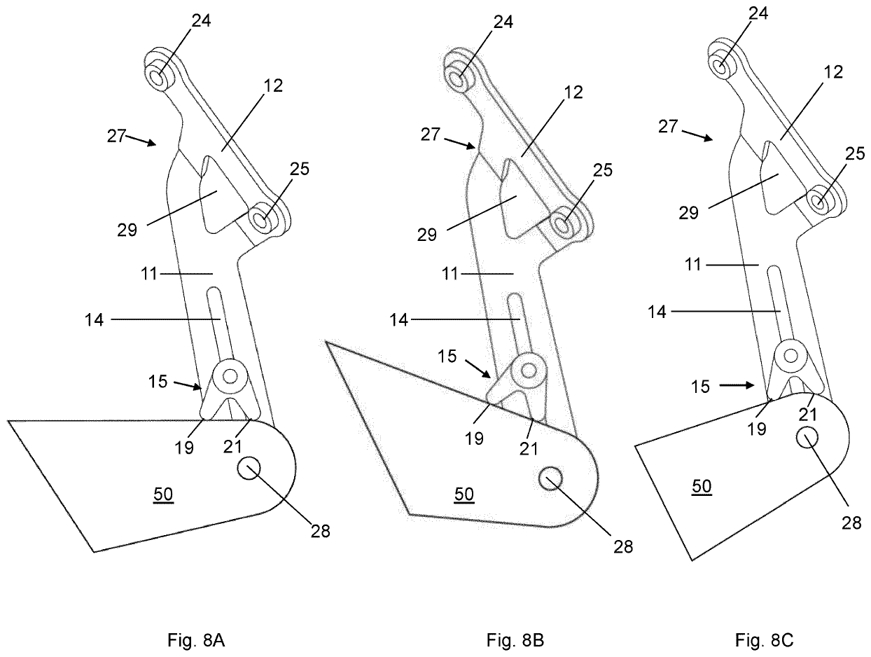

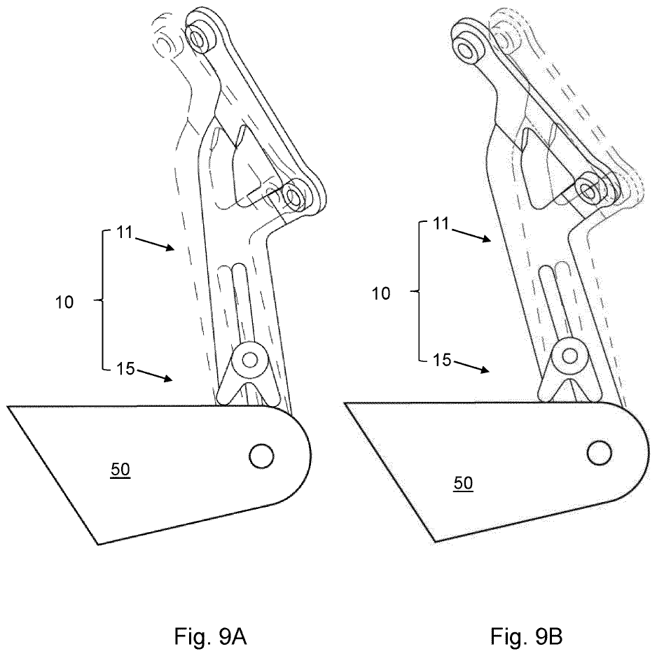

The abutment element 15 of the second variant as attached to the main body 25 of the bracket 10 is shown in FIGS. 8A-9B. FIGS. 8A-8C illustrate how sliding the head portion 16 of the abutment element along the elongate slot 14 can vary the angle that the longitudinal axis of the abutment element forms with the first motorcycle surface (which is on the top surface of the headlight bracket). Similarly to the first variant of the abutment element, varying the angle in the manner allows the bracket to be compatible with differently shaped/sized headlight brackets 50 whose different shape/size causes them to be angled differently relative to the in-use horizontal direction.

Furthermore, varying the longitudinal position of the head portion 16 of the abutment element 15 along the elongate slot 14 can be used to angularly adjust the bracket (and the windshield 30 attached thereto) relative to the headlight bracket 50 of the motorcycle to which the bracket 10 is attached. This is shown in FIGS. 9A-9B where the bracket is tilted along the front to rear direction (and vice versa) to achieve the angular adjustment of the windshield. Conveniently, this functionality can be used to allow the rider to adjust the windshield to better fit their preferences and/or height.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A bracket for attaching a windshield to a motorcycle, the bracket comprising:
a main body comprising a windshield attachment portion for attachment to the windshield, a motorcycle attachment portion for attachment to the motorcycle, and a central portion extending therebetween; and
an abutment element comprising a head portion connected to the main body and an abutment portion extending from the head portion and having a first abutment surface configured to abut a first motorcycle surface to restrict pivoting of the main body about an attachment point of the motorcycle attachment portion to the motorcycle;
wherein the central portion comprises a longitudinally-extending elongate slot and the head portion of the abutment element is slidably mounted in the elongate slot.

2. The bracket of claim 1 wherein the abutment element is rotationally fixed relative to the main body of the bracket.

3. The bracket of claim 2 wherein the head portion comprises at least one anti-rotation projection slidably received within and extending into the elongate slot of the main body of the bracket to rotationally fix the abutment element relative thereto.

4. The bracket of claim 3 wherein the at least one anti-rotation projection is a plurality of linearly arranged anti-rotation projections.

5. The bracket of claim 1 wherein the abutment element is rotatable relative to the main body of the bracket to vary an angle that the first abutment surface forms with the longitudinal axis of the elongate slot.

6. The bracket of claim 1 wherein the abutment portion of the abutment element is bifurcated into a first branch and a second branch, the first branch extending between the head portion and the first abutment surface, and the second branch extending between the head portion and a second abutment surface configured to abut a second motorcycle surface.

7. The bracket of claim 6 wherein the internal angle between the first branch and the second branch is greater than 0 and less than 180 degrees.

8. The bracket of claim 1 wherein the first abutment surface and/or the second abutment surface is a continuous smooth surface.

9. The bracket of claim 8 wherein the first abutment surface and/or the second abutment surface is a rounded convex surface.

10. The bracket of claim 1 wherein the head portion of the abutment element comprises a head bore for reception of an abutment element fastener for fixing the longitudinal position of the abutment element along the elongate slot.

11. A kit for attaching a windshield to a motorcycle, said kit comprising two brackets, each as defined in any one of the preceding claims.

12. A method of manufacturing the bracket as defined in claim 1, the method comprising:
providing a unitary main body blank;
deforming the main body blank to form a fold between the windshield attachment portion and the central portion to form the main body;
providing the abutment element; and
slidably mounting the head portion of the abutment element inside the elongate slot.

13. The method of claim 12 wherein providing the unitary main body blank and/or the abutment element includes integrally moulding respectively the unitary main body blank and/or the head portion with the abutment portion.

14. The method of claim 12 further comprising cutting the main body blank to provide at least the elongate slot.

15. A motorcycle comprising a windshield, the windshield being attached to the motorcycle via at least one bracket as defined in claim 1.
